(19) United States
(12) Patent Application Publication
(10) Pub. No.: US 2014/0189328 A1
(43) Pub. Date: Jul. 3, 2014

(54) POWER REDUCTION BY USING ON-DEMAND RESERVATION STATION SIZE

(71) Applicants: Tomer WEINER, Mahane Miryam, M (IL); Zeev SPERBER, Zichron Yakov (IL); Sagi LAHAV, Kiriay Bialik (IL); Guy PATKIN, Beit-Yanay (IL); Gavri BERGER, Haifa (IL); Itamar FELDMAN, Afula (IL); Ofer LEVY, Atlit (IL); Sara YAKOEL, Karmiel (IL); Adi YOAZ, Hof HaCarmel (IL)

(72) Inventors: Tomer WEINER, Mahane Miryam, M (IL); Zeev SPERBER, Zichron Yakov (IL); Sagi LAHAV, Kiriay Bialik (IL); Guy PATKIN, Beit-Yanay (IL); Gavri BERGER, Haifa (IL); Itamar FELDMAN, Afula (IL); Ofer LEVY, Atlit (IL); Sara YAKOEL, Karmiel (IL); Adi YOAZ, Hof HaCarmel (IL)

(21) Appl. No.: 13/728,696

(22) Filed: Dec. 27, 2012

(51) Int. Cl. G06F 9/30

(52) U.S. Cl. CPC G06F 9/30043
USPC 712/228

(57) ABSTRACT

A computer processor, a computer system and a corresponding method involve a reservation station that stores instructions which are not ready for execution. The reservation station includes a storage area that is divided into bundles of entries. Each bundle is switchable between an open state in which instructions can be written into the bundle and a closed state in which instructions cannot be written into the bundle. A controller selects which bundles are open based on occupancy levels of the bundles.

### FIELD OF THE INVENTION

The present disclosure pertains to computer processors that include a reservation station for temporarily storing instructions whose source operands are not yet available.

### BACKGROUND

Computer processors, in particular microprocessors featuring out-of-order execution of instructions, often include reservation stations to temporarily store the instructions until the source operands of the instructions are available for processing. In this regard, the reservation stations temporarily hold instructions after the instructions have been decoded until the source operands become available. Once all the source operands of a particular instruction are available, the instruction is dispatched from the reservation station to an execution unit that executes the instruction.

Modern processors have the ability to process many instructions simultaneously, e.g., in parallel using multiple processing cores. To support large scale processing, the size of the reservation station continues to grow. The reservation station and its associated hardware (e.g., different types of execution units) consume a significant amount of power. Therefore, as processors become increasingly capable of handling many instructions simultaneously, the need for power saving also increases.

### DESCRIPTION OF THE FIGURES

FIG. 1 is a block diagram of a computer system according to an embodiment of the present invention.

FIG. 2 is a block diagram of processor components according to an embodiment of the present invention.

FIG. 3 is a block diagram of a storage array in a reservation station according to an embodiment of the present invention.

FIG. 4 shows a detailed representation of a portion of the storage array of FIG. 3.

FIG. 5 shows logical states of the state machine for controlling power according to an embodiment of the present invention.

FIG. 6 is a flowchart showing example control decisions made during a normal operating mode.

FIG. 7 is a flowchart showing example control decisions made during a power saving mode.

FIG. 8 is a flowchart showing example control decisions made during a partial power saving mode.

FIG. 9 is a flowchart showing an example procedure for balancing the loading of the storage array in a reservation station.

### DETAILED DESCRIPTION

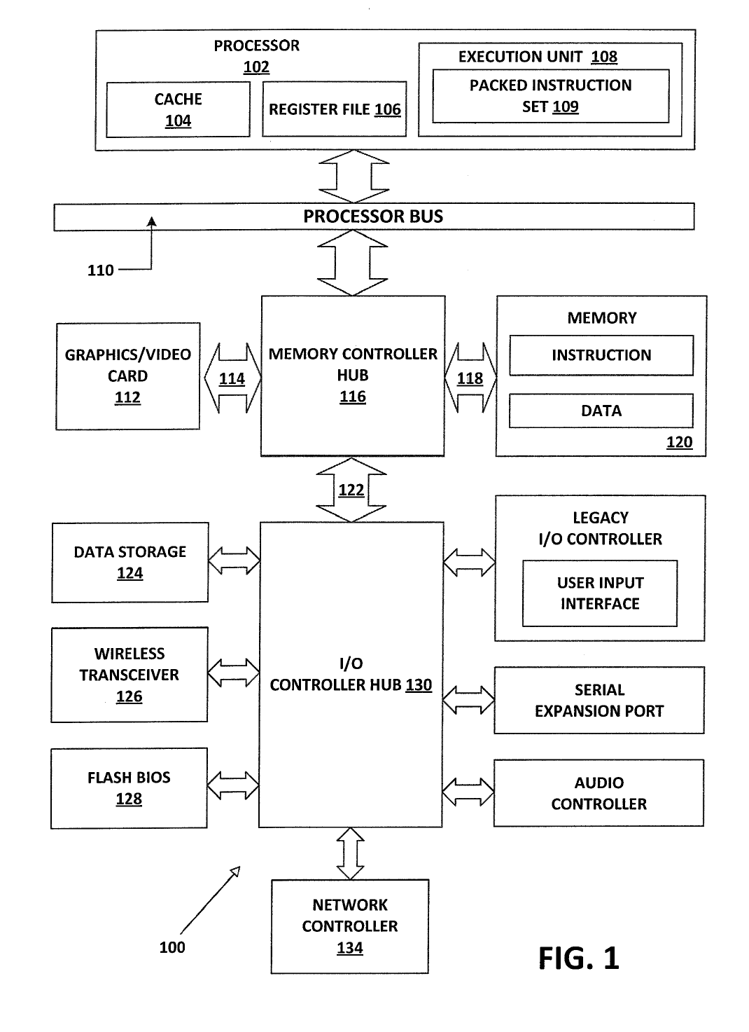

FIG. 1 is a block diagram of a computer system 100 formed with a processor 102 that includes one or more execution units 108 to perform at least one instruction in accordance with an embodiment of the present invention. One embodiment may be described in the context of a single processor desktop or server system, but alternative embodiments can be included in a multiprocessor system. System 100 is an example of a “hub” system architecture. The computer system 100 includes a processor 102 to process data signals. The processor 102 can be a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 102 is coupled to a processor bus 110 that can transmit data signals between the processor 102 and other components in the system 100. The elements of system 100 perform their conventional functions that are well known to those familiar with the art.

In one embodiment, the processor 102 includes a Level 1 (LI) internal cache memory 104. Depending on the architecture, the processor 102 can have a single internal cache or multiple levels of internal cache. Alternatively, in another embodiment, the cache memory can reside external to the processor 102. Other embodiments can also include a combination of both internal and external caches depending on the particular implementation and needs. Register file 106 can store different types of data in various registers including integer registers, floating point registers, status registers, and instruction pointer registers.

Execution unit 108, including logic to perform integer and floating point operations, also resides in the processor 102. The processor 102 also includes a microcode (ucode) ROM that stores microcode for certain macroinstructions. For one embodiment, execution unit 108 includes logic to handle a packed instruction set 109. By including the packed instruction set 109 in the instruction set of a general-purpose processor 102, along with associated circuitry to execute the instructions, the operations used by many multimedia applications may be performed using packed data in a general-purpose processor 102. Thus, many multimedia applications can be accelerated and executed more efficiently by using the full width of a processor's data bus for performing operations on packed data. This can eliminate the need to transfer smaller units of data across the processor's data bus to perform one or more operations one data element at a time.

Alternate embodiments of an execution unit 108 can also be used in micro-controllers, embedded processors, graphics devices, DSPs, and other types of logic circuits. System 100 includes a memory 120. Memory 120 can be a dynamic random access memory (DRAM) device, a static random access memory (SRAM) device, flash memory device, or other memory device. Memory 120 can store instructions and/or data represented by data signals that can be executed by the processor 102.

A system logic chip 116 is coupled to the processor bus 110 and memory 120. The system logic chip 116 in the illustrated embodiment is a memory controller hub (MCH) 116. The processor 102 can communicate to the MCH 116 via a processor bus 110. The MCH 116 provides a high bandwidth memory path 118 to memory 120 for instruction and data storage and for storage of graphics commands, data and textures. The MCH 116 is configured to direct data signals between the processor 102, memory 120, and other components in the system 100 and to bridge the data signals between processor bus 110, memory 120, and system I/O 122. In some embodiments, the system logic chip 116 can provide a graphics port for coupling to a graphics controller 112. The MCH 116 is coupled to memory 120 through a memory interface 118. The graphics card 112 is coupled to the MCH 116 through an Accelerated Graphics Port (AGP) interconnect 114.

System 100 uses a proprietary hub interface bus 122 to couple the MCH 116 to the I/O controller hub (ICH) 130. The ICH 130 provides direct connections to some I/O devices via a local I/O bus. The local I/O bus is a high-speed I/O bus for connecting peripherals to the memory 120, chipset, and processor 102. Some examples are the audio controller, firmware hub (flash BIOS) 128, wireless transceiver 126, data storage 124, legacy I/O controller containing user input and keyboard interfaces, a serial expansion port such as Universal Serial Bus (USB), and a network controller 134. The data storage device 124 can comprise a hard disk drive, a floppy disk drive, a CD-ROM device, a flash memory device, or other mass storage device.

For another embodiment of a system, an instruction in accordance with one embodiment can be used with a system on a chip. One embodiment of a system on a chip comprises of a processor and a memory. The memory for one such system is a flash memory. The flash memory can be located on the same die as the processor and other system components. Additionally, other logic blocks such as a memory controller or graphics controller can also be located on a system on a chip.

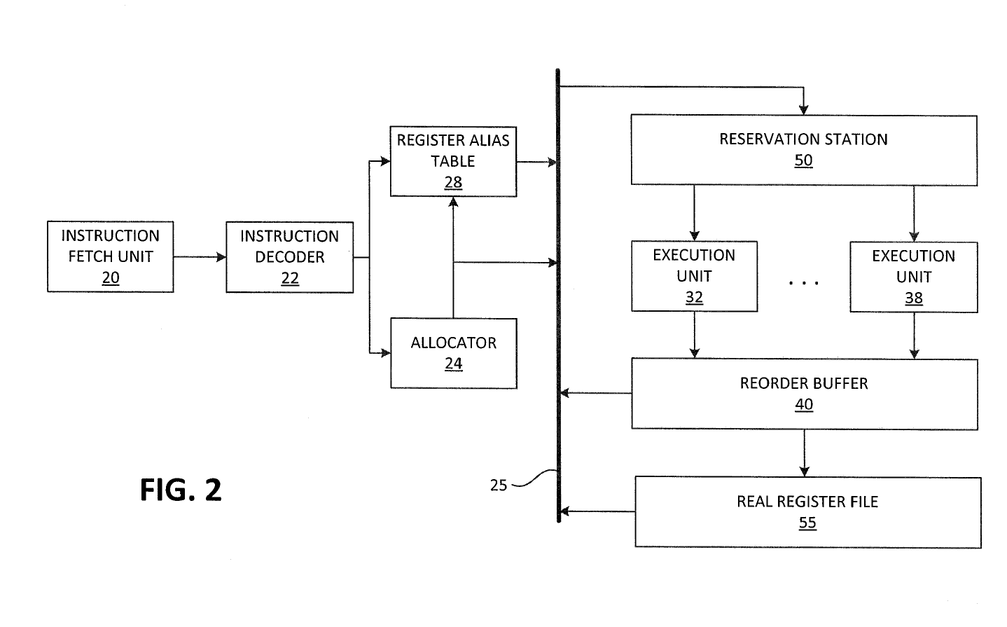

FIG. 2 is a block diagram of processor components according to an embodiment of the present invention. The components include an instruction fetch unit 20, an instruction decoder 22, an instruction allocator 24, a register alias table (RAT) 28, a plurality of execution units 32 to 38, a reorder buffer (ROB) 40, a reservation station 50 and a real register file 55. The components in FIG. 2 may be used to form the processor 102 in FIG. 1, or another processor that implements the teachings of the present invention.

The instruction fetch unit 20 forms part of a processor front-end and fetches at least one instruction per clock cycle from an instruction storage area such as an instruction register (not shown). The instructions may be fetched in-order. Alternatively the instructions may be fetched out-of-order depending on how the processor is implemented.

The instruction decoder 22 obtains the instructions from the fetch unit 20 and decodes or interprets them. For example, in one embodiment, the decoder 22 decodes a received instruction into one or more operations called “micro-instructions” or “micro-operations” (also called micro ops or uops) that the processor can execute. In other embodiments, the decoder parses 22 the instruction into an opcode and corresponding data and control fields. Some instructions are converted into a single uop, whereas others may need several micro-ops to complete the full operation. In one embodiment, instructions may be converted into single uops, which can be further decoded into a plurality of atomic operations. Such uops are referred to as “fused uops”. After decoding, the decoder 22 passes the uops to the RAT 28 and the allocator 24.

The allocator 24 may assemble the incoming uops into program-ordered sequences or traces before assigning each uop to a respective location in the ROB 40. The allocator 24 maps the logical destination address of a uop to its corresponding physical destination address. The physical destination address may be a specific location in the real register file 55. The RAT 28 maintains information regarding the mapping.

The ROB 40 temporarily stores execution results of uops until the uops are ready for retirement and, in the case of a speculative processor, until ready for commitment. The contents of the ROB 40 may be retired to their corresponding physical locations in the real register file 55.

Each incoming uop is also transmitted by the allocator 24 to the reservation station 50. In one embodiment, the reservation station 50 is implemented as an array of storage entries in which each entry corresponds to a single uop and includes data fields that identify the source operands of the uop. When the source operands of a uop become available, the reservation station 50 selects an appropriate execution unit 32 to 38 to which the uop is dispatched. The execution units 32 to 38 may include units that perform memory operations, such as loads and stores, and may also include units that perform non-memory operations, such as integer or floating point arithmetic operations. Results from the execution units 32 to 38 are written back to the reservation station 50 via a writeback bus 25.

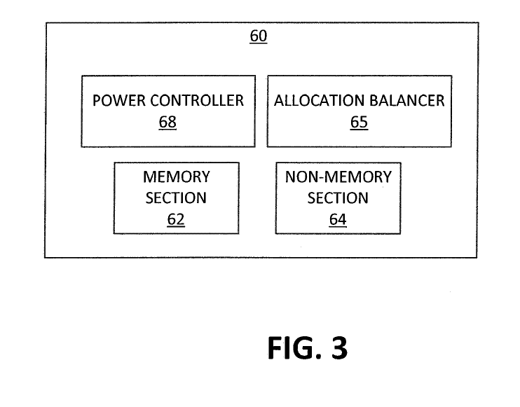

FIG. 3 is a block diagram of a storage array 60 in a reservation station according to an example embodiment of the present invention. The storage array 60 is organized into at least two sections, e.g., a memory section 62 and a non-memory section 64. The memory section 62 holds entries for uops that involve memory operations (e.g., loads and stores), while the non-memory section 64 holds entries for uops that involve non-memory operations (e.g., add, subtract and multiply). The storage array 60 may also include an allocation balancer 65 and a power controller 68, which can be centrally located in the storage array 60 or the reservation station 50. Alternatively, each section 62, 64 may be provided with a separate power controller or a separate balancer. In an alternative embodiment, the storage array 60 may have only one section in which both memory and non-memory instructions are stored.

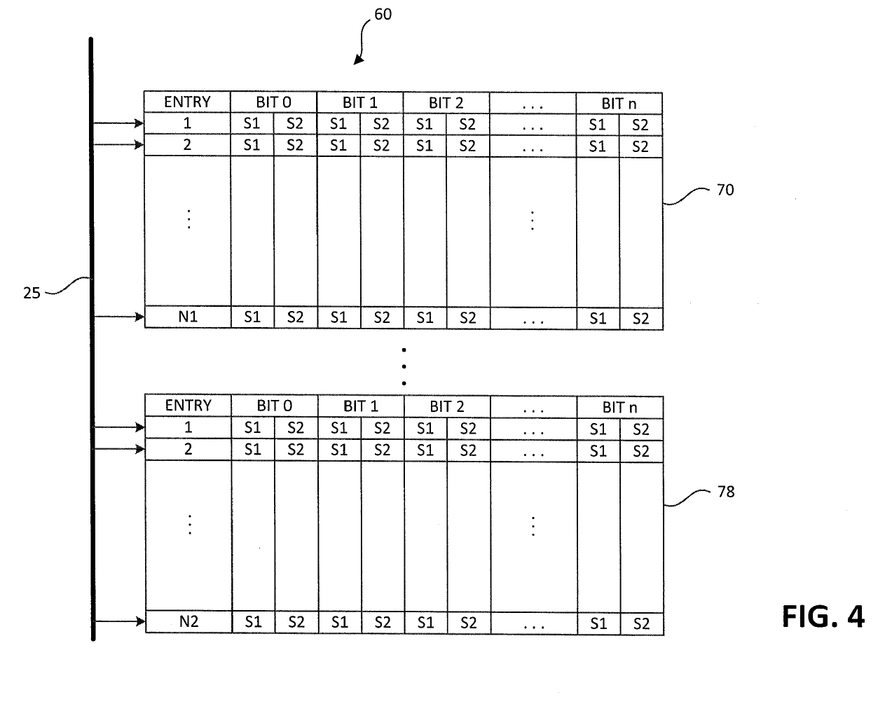

FIG. 4 shows a detailed representation of a portion of the storage array 60, which in an example embodiment is organized into a plurality of entry bundles 70 to 78. Each bundle includes a plurality of entries. For example, the bundles 70, 78 shown respectively include N1 and N2 entries. The bundles 70, 78 represent bundles in either the memory section 62 or the non-memory section 64. The number of entries in each bundle may be different or the same (that is, N1 and N2 may or may not be different). As mentioned above, in one embodiment, each entry has a single write port for incoming uops.

Each entry includes n bits which store the information for a respective uop, including the uop itself, source operands for the uop, and control bits indicating whether a particular source operand contains valid data. In one embodiment, the bits are memory cells that are interleaved between two source operands S1 and S2, so that each bit includes a cell for source S1 and a separate cell for source S2. The example storage array 60 includes a single write port in each entry for writing data of an incoming uop. These write ports are represented by arrows that connect the entries to the writeback bus 25. In a conventional processor, each uop can typically be allocated into any entry in the reservation station, such that single entries can store information for multiple uops, and therefore the entries have multiple write ports (e.g., four write ports per entry in a processor where four uops are allocated to the reservation station each clock cycle). An advantage of having only one write port per entry is that each entry can be limited to storing information for a single uop, which reduces the physical size of the entries. For example, it is not necessary to have wires for control signals that indicate which one of a plurality of write ports is active. Reducing size therefore results in a shortening of transmission time in the dispatch loop formed by the reservation station 50 and the execution units 32 to 38, allowing the reservation station to more easily meet any timing requirements imposed on the dispatch loop. Another advantage, which will become apparent from the discussion below, is that the use of one write port per entry facilitates the power reduction techniques of the present invention. The allocation bandwidth may be greater than one, with for example, up to four instructions being allocated each cycle as is the case with the conventional processor. Accordingly, each bundle may be provided with at least one respective multiplexer (not shown) that, when triggered, selects one of the incoming uops for writing to a particular entry in the bundle. Each uop multiplexer serves several entries belonging to the same bundle, and each entry includes a single write port for incoming uops. One of the incoming uops (e.g., one out of four incoming uops) is thus written into one of the entries in a bundle using a multiplexer associated with that bundle.

In addition to the single write port for incoming uops, each entry may include additional write ports connected to the writeback bus 25 for writing data transmitted from the ROB 40, the RAT 28 and the register file 55. As the present invention is primarily concerned with the allocation of uops to the reservation station after decoding, details regarding these additional write ports and the writeback process that occurs through these additional write ports have been omitted. However, one of ordinary skill in the art would understand how to implement the omitted features in a conventional manner. For example, it will be understood that execution results may be written back to the reservation station 50 from the ROB 40 in order to provide updated source operands that are needed for the execution of a uop waiting in the reservation station 50.

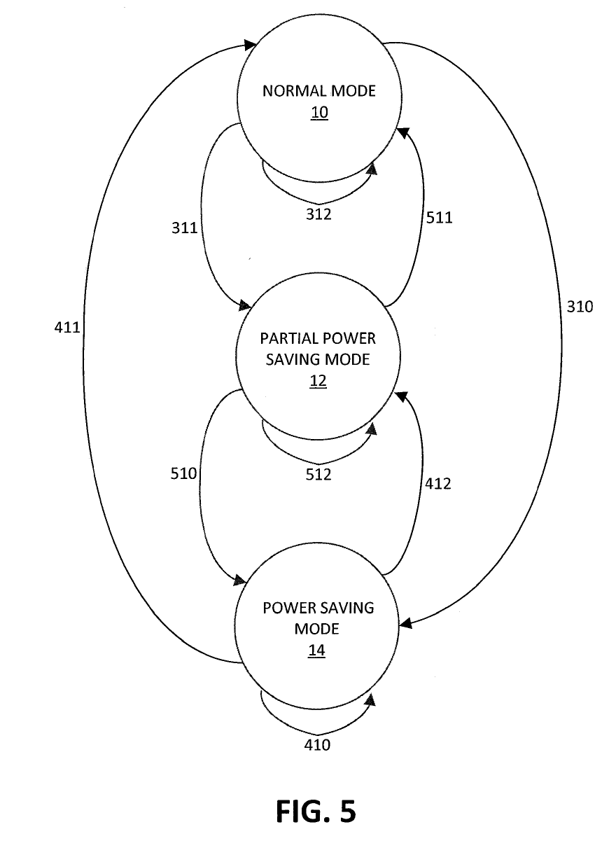

FIG. 5 is an example embodiment of a state diagram showing logical states of the power controller 68. The logical states include a normal mode 10, a partial power saving mode 12 and a power saving mode 14. Hardware, software, or a combination thereof may be used to implement a state machine in accordance with the state diagram. For example a hardware embodiment may include an application-specific integrated circuit (ASIC), a field-programmable gate array (FPGA) or a micro-controller. Each state includes transitions to the other states as well as a transition back to the same state. In normal mode 10, transition 310 involves going to power saving mode 14, transition 311 involves going to partial mode 12, and transition 312 involves remaining in normal mode 10.

In partial mode 12, transition 510 involves going to power saving mode 14, transition 511 involves going to normal mode 10, and transition 512 involves remaining in partial mode 12.

In power saving mode 14, transition 410 involves remaining in power saving mode 14, transition 411 involves going to normal mode 10, and transition 412 involves going to partial mode 12.

Each of the three modes 10, 12, 14 applies a particular section 62, 64. In the described embodiments, the operating modes of the sections 62, 64 are determined separately, so that one section may operate under a different mode than the other section. However, in an alternative embodiment, a single operating mode may apply to both sections 62, 64.

In normal mode 10, all the bundles in the section are available for writing an incoming uop. This is referred to as all the bundles being “open”. In the partial mode 12, some of bundles are made unavailable for writing incoming uops (i.e., some of the bundles are “closed”). In the power saving mode 14, the least amount of bundles are made available. For example, the power saving mode 14 may have the same number of open bundles as the allocation bandwidth of the processor. Specifically, if up to four uops are written each cycle to the non-memory section 64, then the power saving mode 14 of the non-memory section 64 may involve four open bundles with the remaining bundles being closed. The open bundles in the power saving mode 14 are referred to as the “always-on” bundles because at least this amount of bundles need to be open at any time. In the described embodiments, the locations of the always-on bundles are fixed. However, in other embodiments, it may be possible to dynamically select the always-on bundles as different bundles become open and closed.

Power reduction is achieved by switching to either the partial mode 12 or the power saving mode 14 when it is determined that not all of the bundles need to be open, thereby reducing power consumed by the reservation station 50 and its associated hardware. It is noted that when switching to as less power-consuming mode, actual power reduction may not immediately result because the instructions that are residing in newly closed bundles still need to be dispatched for execution. Once the instructions have been dispatched, power to the closed bundles may be switched off using appropriate control devices, e.g., control logic in the power controller 68 and corresponding switches that connect each bundle to a power source in response to control signals from the control logic.

Although the described embodiments involve a partial power saving mode, other embodiments may involve as few as two modes, i.e., a normal mode in which all the bundles are open, and a power saving mode in which fewer than all the bundles are open. Still further embodiments may involve additional power saving modes with varying amounts of open bundles.

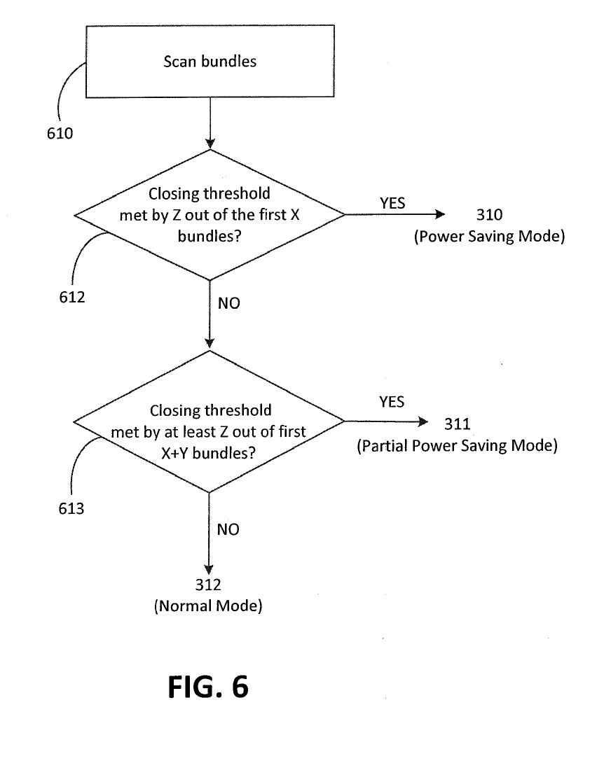

Flow charts showing example control techniques for power reduction will now be described. The techniques are applicable to either section 62, 64. FIG. 6 is a flowchart showing example control decisions made by the power controller 68 during the normal mode 10. At 610, all the bundles in the section are scanned to determine the degree of occupancy of each bundle. The bundles can be scanned all at once. Alternatively, the bundles can be scanned on an as-needed basis.

At 612, it is determined whether a closing threshold has been met by Z out of the first X bundles. X refers to the number of always-on bundles and may be set equal to the allocation bandwidth, e.g., in a four uop per cycle processor, X equals four. Alternatively, X can be larger than the allocation bandwidth (e.g., X=5). Z is the allocation bandwidth (the number of uops allocated to each bundle per cycle) and therefore, at least Z open bundles are needed, hence X should be equal to or greater than Z. The closing threshold is any value less than the total number of entries in the bundle (e.g., closing threshold=4). The closing threshold is met with respect to a particular bundle when the number of unused entries in the bundle is equal to or greater than the closing threshold, in which case this may be an indication that some of the currently open bundles can be closed.

If Z out of the first X bundles meet the closing threshold, this means that the first X bundles are considered to have sufficient capacity to handle all incoming instructions. In this case, a switch (310) is made to power saving mode 14, where only the first X bundles (1 to X) are open.

If fewer than Z of the first X bundles meet the closing threshold, then it may be determined whether at least Z out of the first X+Y bundles meet the closing threshold (613). Y can be any number such that the sum X+Y is less than the total number of entries in the bundle. When this condition is met, the incoming uops can be allocated using a portion of the entire bundle, and a switch (311) is made to the partial mode 12, where only the first X+Y bundles (1 to X+Y) are open. In an example embodiment, Z=4, X=4 and Y=2 so that the relevant consideration is whether it is possible to allocate to four out of the first six bundles. In another embodiment, Y can be iteratively increased and the comparison in (613) repeated for each Y increase. That is, Y can be increased several times (e.g., Y1=1, Y2=2 and Y3=3, etc.) as long as X+Y is less than the total number of bundles. In this other embodiment, a Y value associated with switching to normal mode (e.g., Y3) may be different from a Y value associated with switching to partial mode (e.g., Y2).

If Z of the first X+Y bundles meet the closing threshold, this means that the first X+Y bundles are considered to have sufficient capacity to handle all incoming instructions and the remaining bundles can be closed. If Z out of the first X+Y bundles fail to meet the closing threshold, then a switch (312) is made back to the normal mode 10, i.e., all the bundles are kept open.

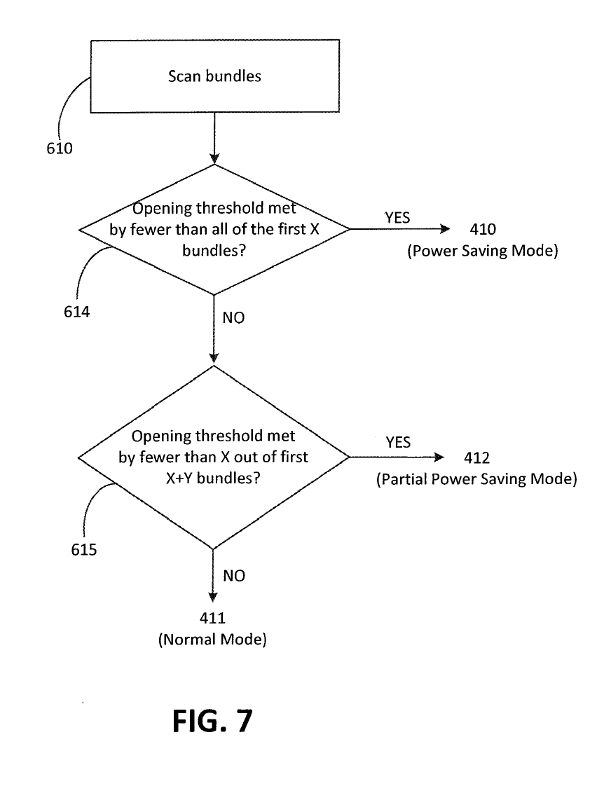

FIG. 7 is a flowchart showing example control decisions made by the power controller 68 during the power saving mode 14. After the bundles are scanned (610), it may be determined whether fewer than all of the first X bundles meet an opening threshold (614). The opening threshold can be any number greater than one and is preferably greater than the closing threshold (e.g., 6 when the closing threshold is 4). Alternatively, the opening threshold can be the same as the closing threshold. The opening threshold is met with respect to a particular bundle when the number of unused entries in the bundle is less than or equal to the opening threshold, in which case this may be an indication that additional bundles need to be opened. The opening threshold is set such that allocation can continue to the already open bundles while the opening of the additional bundles occurs. Therefore, the opening threshold should be large enough that the switch from power saving mode 14 to normal mode 10 or to partial mode 12 will occur while there are sufficient unused entries in the always-on bundles to accommodate incoming uops during a delay period measured from the time the decision to switch modes is made to the time that the additional bundles actually become open and available for writing. In this regard, setting the opening threshold greater than the closing threshold means it is easier to open bundles than to close bundles, and increases the likelihood that sufficient unused entries are available during the delay period.

If fewer than all of the first X bundles meet the opening threshold, this means that it is possible to allocate to all X bundles without the need to open additional bundles, and a switch (410) is made back to the power saving mode 14, where only the always-on bundles (e.g., 1 to X) are open.

If all of the first X bundles meet the opening threshold, then it may be determined whether fewer than X out of the first X+Y bundles meet the opening threshold (615). In the example where X=4 and Y=2, this means determining whether it is possible to allocate to at least 4 out of the first 6 bundles. If fewer than X out of the first X+Y bundles meet the opening threshold, this is an indication that some, but not all of the remaining bundles need to be opened, and a switch (412) is made to the partial mode 12, where more bundles are open compared to the power saving mode 14.

If at least X out of the first X+Y bundles meet the opening threshold, this is an indication that all of the bundles may be needed and a switch (411) is made to the normal mode 10.

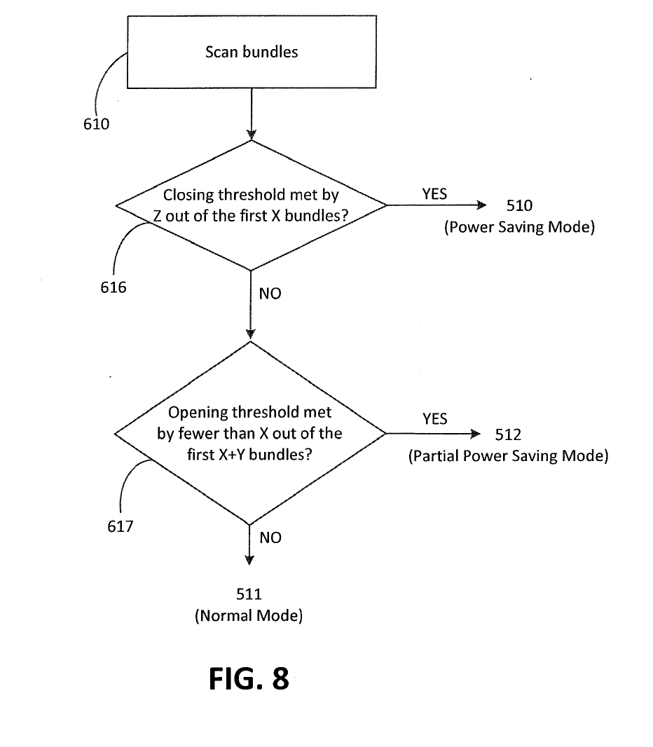

FIG. 8 is a flowchart showing example control decisions made by the power controller 68 during the partial mode 12. After the bundles are scanned (610), it may be determined whether Z out of the first X bundles meet the closing threshold (616). This determination is the same as that made in 612 of FIG. 6 and if the condition is met, a switch (510) is made to the power saving mode 14, where fewer bundles are open compared to the partial mode 12.

If the condition in 616 is not met, then it may be determined whether the opening threshold is met by fewer than X out of the first X+Y bundles (617). This determination is the same as that made in 615 of FIG. 7 and if the condition is met, a switch (512) is made back to the partial mode 12. However, if the condition is not met, a switch (511) is made to the normal mode 10.

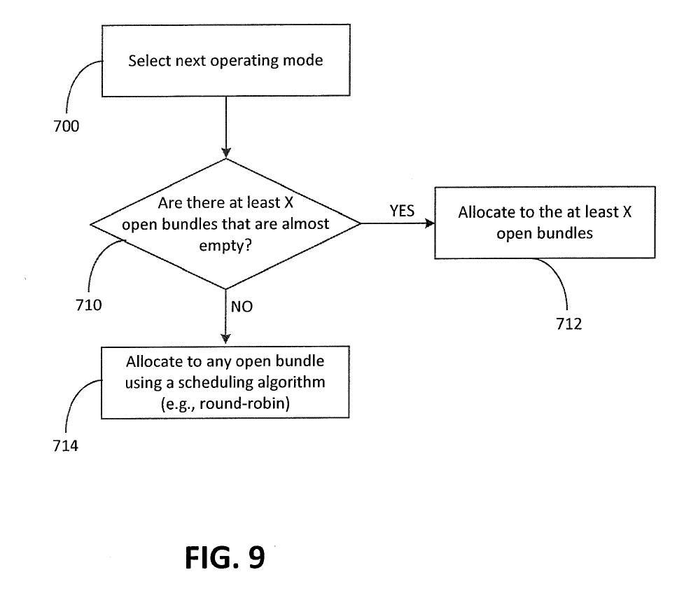

The example power reduction techniques discussed above guarantee that there are enough open bundles to support the allocation bandwidth, while restricting the number of open bundles when less than all of the bundles are needed. As a complement to the power reduction techniques, load balancing techniques may be applied to evenly distribute the allocation of incoming uops among the open bundles. FIG. 9 is a flowchart showing an example balancing procedure that can be performed by the allocation balancer 65 to balance the loading of the open bundles in either section 62, 64. As with the power controller 68, the allocation balancer 65 can be implemented using a state machine or logic components, in hardware, software or a combination thereof. At 700, the next operating mode is selected based on the current operating mode, and based on the current operating mode, for example as shown in FIGS. 5 to 7. The open or closed state of the bundles is adjusted in accordance with the next operating mode, after which a determination is made whether there are at least X open bundles that are almost empty (710). This determination can be made by comparing the occupancy of each of the open bundles to a threshold value Z. In an example embodiment, Z equals the total number of entries in a bundle minus three. Thus, a bundle is considered almost empty when it has no more than three entries being used.

If there are at least X open bundles that are almost empty, then it may be preferable to allocate to these bundles (e.g., up to one uop per bundle) in order to avoid writing to bundles that are comparatively fuller. Accordingly, the incoming uops are allocated to the at least X open bundles (712). If the number of almost empty bundles exceeds the allocation bandwidth, the almost empty bundles may be selected for allocation based on sequential order (e.g., using a round robin scheduling algorithm), selected at random, or based on loading (e.g., bundles with the least number of entries are selected first).

If there are fewer than X open bundles that are almost empty, this means that most of the open bundles are nearly full. In this case, it may not matter which open bundles are selected for allocation since the open bundles are somewhat balanced. However, it may still be desirable to maintain full balancing, in which case allocation may be performed by selecting from any of the open bundles using a scheduling algorithm (714). In an example embodiment, the scheduling algorithm is a round-robin algorithm in which the allocation balancer 65 keeps track of which bundle was last used and allocates to the next-sequential open bundle that follows the last-used bundle.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A computer processor, comprising:
a reservation station that stores instructions which are not ready for execution, wherein the reservation station includes a storage area that is divided into bundles of entries, and each bundle is switchable between an open state in which instructions can be written into the bundle and a closed state in which instructions cannot be written into the bundle; and
a controller that selects which bundles are open based on occupancy levels of the bundles.

2. The processor of claim 1, wherein the processor turns power off for closed bundles.

3. The processor of claim 2, wherein closed bundles remain powered until all instructions stored in a respective closed bundle have been dispatched for execution.

4. The processor of claim 1, wherein the storage area stores memory instructions in bundles separate from those in which non-memory instructions are stored.

5. The processor of claim 4, wherein the controller selects the open bundles of the memory instruction bundles independently of selecting the open bundles of the non-memory instruction bundles, based on the respective occupancy levels of the memory and the non-memory instruction bundles.

6. The processor of claim 1, wherein the controller operates the bundles in one of at least two modes, including a normal mode in which all the bundles are open, and a power saving mode in which some of the bundles are closed.

7. The processor of claim 6, wherein in the normal mode, the controller switches to a different one of the at least two modes in response to determining that a specified number of bundles meet a closing threshold, which is met with respect to a particular bundle when the number of unused entries in the bundle is equal to or greater than the closing threshold.

8. The processor of claim 6, wherein in the power saving mode, the controller switches to a different one of the at least two modes in response to determining that a specified number of bundles meet an opening threshold, which is met with respect to a particular bundle when the number of unused entries in the bundle is less than or equal to the opening threshold.

9. The processor of claim 6, wherein the at least two modes includes a partial mode in which fewer bundles are closed relative to the power saving mode.

10. The processor of claim 9, wherein in the partial mode, the controller:
switches to the power saving mode in response to determining that a first specified number of bundles meet a closing threshold, which is met with respect to a particular bundle when the number of unused entries in the bundle is equal to or greater than the closing threshold; and
switches to the normal mode in response to determining that a second specified number of bundles meet an opening threshold, which is met with respect to a particular bundle when the number of unused entries in the bundle is less than or equal to the opening threshold.

11. The processor of claim 1, further comprising:
a balancer unit that controls allocation of instructions into open bundles by selecting bundles for allocation in accordance with a scheduling algorithm that balances utilization of the open bundles.

12. The processor of claim 11, wherein the scheduling algorithm is a round-robin algorithm.

13. The processor of claim 11, wherein the scheduling algorithm is executed only when there are less than a threshold number of almost-empty bundles, the instructions being allocated without executing the scheduling algorithm when the number of almost-empty bundles is at least the threshold number.

14. A system, comprising:
a computer processor; and
a memory that stores instructions to be executed by the processor;
the processor including:
a reservation station that stores instructions which are not ready for execution, wherein the reservation station includes a storage area that is divided into bundles of entries, and each bundle is switchable between an open state in which instructions can be written into the bundle and a closed state in which instructions cannot be written into the bundle;
a controller that selects which bundles are available based on occupancy levels of the bundles; and
an allocator that allocates decoded instructions to open bundles in the reservation station.

15. A method comprising:
storing instructions in a reservation station of a computer processor prior to execution, wherein a storage area of the reservation station is divided into bundles of entries, and each bundle is switchable between an open state in which instructions can be written into the bundle and a closed state in which instructions cannot be written into the bundle; and
selecting with a controller which bundles are available based on occupancy levels of the bundles.

16. The method of claim 15, further comprising:
turning power off for closed bundles.

17. The method of claim 16, further comprising:
keeping closed bundles powered until all instructions stored in a respective closed bundle have been dispatched for execution.

18. The method of claim 15, further comprising:
storing memory instructions in bundles separate from those in which non-memory instructions are stored.

19. The method of claim 18, further comprising:
configuring the controller to select the open bundles of the memory instruction bundles independently of selecting the open bundles of the non-memory instruction bundles, based on the respective occupancy levels of the memory and the non-memory instruction bundles.

20. The method of claim 15, further comprising:
operating the bundles in one of at least two modes, including a normal mode in which all the bundles are open, and a power saving mode in which some of the bundles are closed.

21. The method of claim 20, further comprising:
in the normal mode, switching to a different one of the at least two modes in response to determining that a specified number of bundles meet a closing threshold, which is met with respect to a particular bundle when the number of unused entries in the bundle is equal to or greater than the closing threshold.

22. The method of claim 20, further comprising:
in the power saving mode, switching to a different one of the at least two modes in response to determining that a specified number of bundles meet an opening threshold, which is met with respect to a particular bundle when the number of unused entries in the bundle is less than or equal to the opening threshold.

23. The method of claim 20, wherein the at least two modes includes a partial mode in which fewer bundles are closed relative to the power saving mode.

24. The method of claim 23, further comprising, in the partial mode:
switching to the power saving mode in response to determining that a first specified number of bundles meet a closing threshold, which is met with respect to a particular bundle when the number of unused entries in the bundle is equal to or greater than the closing threshold; and
switching to the normal mode in response to determining that a second specified number of bundles meet an opening threshold, which is met with respect to a particular bundle when the number of unused entries in the bundle is less than or equal to the opening threshold.

25. The method of claim 15, further comprising:
controlling allocation of instructions into open bundles by selecting bundles for allocation in accordance with a scheduling algorithm that balances utilization of the open bundles.

26. The method of claim 25, wherein the scheduling algorithm is a round-robin algorithm.

27. The method of claim 25, further comprising:
performing the scheduling algorithm only when there are less than a threshold number of almost-empty bundles, the instructions being allocated without executing the scheduling algorithm when the number of almost-empty bundles is at least the threshold number.
